(19) United States
(12) Patent Application Publication
(10) Pub. No.: US 2011/0235125 A1
(43) Pub. Date: Sep. 29, 2011

(54) PRINTING APPARATUS, CORRECTION VALUE CALCULATING METHOD, AND STORAGE MEDIUM

(75) Inventors: MASAHIKO YOSHIDA, SHIOJIRI-SHI (JP); TAKESHI YOSHIDA, SHIOJIRI-SHI (JP); MICHIAKI TOKUNAGA, MATSUMOTO-SHI (JP); TATSUYA NAKANO, SHIOJIRI-SHI (JP)

(73) Assignee: SEIKO EPSON CORPORATION, TOKYO (JP)

(21) Appl. No.: 13/072,116

(22) Filed: Mar. 25, 2011

(30) Foreign Application Priority Data
Mar. 26, 2010 (JP) 2010-073652

(51) Int. Cl. H04N 1/405

(52) U.S. Cl. 358/3.03

(57) ABSTRACT

A correction value calculating method includes: printing a pattern based on an instruction gray scale value indicating a predetermined density; acquiring a read gray scale value, which is a result obtained when a scanner reads the pattern, for each line area; calculating a first correction value, which is a correction value of each line area corresponding to a middle portion of the pattern, based on the read gray scale value of each line area corresponding to the middle portion of the pattern; and calculating a second correction value, which is a correction value of the line area corresponding to an end portion of the pattern in the predetermined direction, based on the read gray scale value of the line area in the vicinity of the line area corresponding to the end portion of the pattern.

### BACKGROUND

1. Technical Field

The present invention relates to a correction value calculating method, a printing apparatus manufacturing method, and a program.

2. Related Art

As a printing apparatus, an ink jet printer (hereinafter, referred to as a printer) is known that performs printing by ejecting ink from nozzles toward various kinds of media such as a sheet, a cloth, and a film. In such a printer, density irregularity may sometimes occur due to a problem with a processing precision of the nozzles. For example, when ink droplets from given nozzles fly in a curved manner, not only the density of an image piece formed by the nozzles but also the density of an image piece adjacent to the image piece are influenced. Therefore, density irregularity may not be suppressed by correction values simply according to the nozzles.

In order to solve this problem, a method of setting a correction value for each area (hereinafter, referred to as a line area) on a medium on which the image piece is formed was suggested (for example, see JP-A-2007-1141).

When a test pattern used to calculate a correction value is read by a scanner, the margin of a sheet has an influence on the read result of an end portion of the test pattern. Therefore, when correction is not performed on a line area on which the margin of a sheet has an influence, the boundary between the line area not subjected to correction and the line area subjected to correction is visibly noticeable, thereby deteriorating the quality of an image.

### SUMMARY

An advantage of some aspects of the invention is that it provides a technique for preventing image quality from deteriorating.

According to an aspect of the invention, there is provided a correction value calculating method including: (a) printing a pattern based on an instruction gray scale value indicating a predetermined density by a printing apparatus, which performs the printing by ejecting ink from nozzles and forming dot lines in an intersection direction intersecting a predetermined direction, while moving nozzle lines in which the nozzles ejecting the ink on a medium are lined up in the predetermined direction and the medium relatively in the intersection direction; (b) acquiring a read gray scale value, which is a result obtained when a scanner reads the pattern, for each line area which is an area in which the dot line is formed in the intersection direction on the medium; (c) calculating a first correction value, which is a correction value of each line area corresponding to a middle portion of the pattern in the predetermined direction, based on the read gray scale value of each line area corresponding to the middle portion of the pattern; and (d) calculating a second correction value, which is a correction value of the line area corresponding to an end portion of the pattern in the predetermined direction, based on the read gray scale value of the line area in the vicinity of the line area corresponding to the end portion of the pattern.

Other aspects of the invention are apparent by description of the specification and the accompanying drawings.

### BRIEF DESCRIPTION OF THE DRAWINGS

The invention will be described with reference to the accompanying drawings, wherein like numbers reference like elements.

FIG. 1 is a block diagram illustrating the entire configuration of a printer.

FIG. 2A is a schematic sectional view illustrating the printer.

FIG. 2B is a schematic plan view illustrating the printer.

FIG. 3 is a diagram illustrating the arrangement of heads.

FIG. 4A is a diagram illustrating a printing method of completely printing an image by one pass.

FIG. 4B is a diagram illustrating a printing method of completely printing an image by a plurality of passes.

FIG. 5 is a diagram illustrating a printing method in which an upper end process, a lower end process, and a normal process are performed.

FIG. 6 is a diagram illustrating a cause of density irregularity.

FIG. 7 is a flowchart illustrating calculation of a correction value for the density irregularity.

FIG. 8 is a diagram illustrating test patterns.

FIG. 9A is a diagram illustrating read result of the test patterns.

FIGS. 9B and 9C are diagrams illustrating correction value calculating methods according to a comparative example.

FIG. 10 is a diagram illustrating a normal correction value application range and a dummy correction value application range.

FIGS. 11A and 11B are diagrams illustrating specific methods of calculating the normal correction value.

FIG. 12 is a diagram illustrating a correction value table.

FIG. 13 is a diagram illustrating a dummy correction value calculation range.

FIG. 14 is a diagram illustrating a complete correction value table.

FIG. 15 is a diagram illustrating calculation of the correction value corresponding to each gray scale value.

FIG. 16 is a diagram illustrating a method of calculating a dummy correction value according to a second embodiment.

FIG. 17 is a diagram illustrating the read gray-scale value of the test pattern in a printer including one head.

### DESCRIPTION OF EXEMPLARY EMBODIMENTS

### Disclosure Overview

At least the following aspects of the invention are apparent by description of the specification and the accompanying drawings.

According to an aspect of the invention, there is provided a correction value calculating method including: (a) printing a pattern based on an instruction gray scale value indicating a predetermined density by a printing apparatus, which performs the printing by ejecting ink from nozzles and forming dot lines in an intersection direction intersecting a predetermined direction, while moving nozzle lines in which the nozzles ejecting the ink on a medium are lined up in the predetermined direction and the medium relatively in the intersection direction; (b) acquiring a read gray scale value, which is a result obtained when a scanner reads the pattern, for each line area which is an area in which the dot line is formed in the intersection direction on the medium; (c) calculating a first correction value, which is a correction value of each line area corresponding to a middle portion of the pattern in the predetermined direction, based on the read gray scale value of each line area corresponding to the middle portion of the pattern; and (d) calculating a second correction value, which is a correction value of the line area corresponding to an end portion of the pattern in the predetermined direction, based on the read gray scale value of the line area in the vicinity of the line area corresponding to the end portion of the pattern.

According to the correction value calculating method, the correction value for correcting the density irregularity of the line area where the margin is likely to have an influence on the result read by the scanner can be calculated, thereby preventing the image quality from deteriorating.

In the correction value calculating method, the printing apparatus including the plurality of heads each including the nozzle line prints the pattern. In order to calculate the second correction value by printing the pattern, the line area used to calculate the second correction value may include the line area to which the same head as the head allocated to the line area corresponding to the end portion of the pattern is allocated.

According to the correction value calculating method, the second correction value according to the characteristics of the head allocated to the line areas corresponding to the end portion can be calculated, thereby suppressing density irregularity.

In the correction value calculating method, the line area used to calculate the second correction value may not include the line area to which the head different from the head allocated to the line area corresponding to the end portion of the pattern is allocated.

According to the correction value calculating method, the second correction value according to the characteristics of the head allocated to the line areas corresponding to the end portion can be calculated, thereby suppressing density irregularity.

In the correction value calculating method, the line area used to calculate the second correction value may not include the line area corresponding to the end portion of the pattern.

According to the correction value calculating method, the second correction value can be calculated based on the read gray scale value of the line area on which the margin has no influence, thereby preventing the image quality from deteriorating.

In the correction value calculating method, the second correction value may be calculated based on the first correction value of the line area used to calculate the second correction value.

According to the correction value calculating method, the correction value for correcting the density irregularity of the line area where the margin is likely to have an influence on the result read by the scanner can be calculated, thereby preventing the image quality from deteriorating.

In the correction value calculating method, an average value of the first correction values of a plurality of the line areas used to calculate the second correction value is calculated as the second correction value.

According to the correction value calculating method, the correction value for averagely correcting the densities of the line areas corresponding to the end portions can be calculated.

According to another aspect of the invention, there is provided a method of manufacturing a printing apparatus which ejects ink from nozzles, while moving a nozzle line in which the nozzles ejecting the ink toward a medium are lined up in a predetermined direction and the medium relatively in an intersection direction intersecting the predetermined direction. The printing apparatus prints a pattern based on an instruction gray scale value indicating a predetermined density, acquires a read gray scale value, which is a result obtained when a scanner reads the pattern, for each line area which is an area in which the dot line is formed in the intersection direction on the medium, calculates a first correction value, which is a correction value of each line area corresponding to a middle portion of the pattern in the predetermined direction, based on the read gray scale value of each line area corresponding to the middle portion of the pattern, and calculates a second correction value, which is a correction value of the line area corresponding to an end portion of the pattern in the predetermined direction, based on the read gray scale value of the line area in the vicinity of the line area corresponding to the end portion of the pattern. Thus, the printing apparatus stores the first correction value and the second correction value in a storage unit included by the printing apparatus.

According to the method of manufacturing the printing apparatus, it is possible to manufacture a printing apparatus capable of correcting density irregularity of the line area where the margin is likely to have an influence on the result read by the scanner.

According to still another aspect of the invention, there is provided a program causing a computer to calculate a correction value for correcting density of an image printed by a printing apparatus which ejects ink from nozzles while moving a nozzle line in which the nozzles ejecting the ink toward a medium in a predetermined direction and the medium relatively in a direction intersecting the predetermined direction. The program causes the computer to: allow the printing apparatus to print a pattern based on an instruction gray scale value indicating a predetermined density by the printing apparatus; acquire a read gray scale value, which is a result obtained when a scanner reads the pattern, for each line area which is an area in which the dot line is formed in the intersection direction on the medium; calculates a first correction value, which is a correction value of each line area corresponding to a middle portion of the pattern in the predetermined direction, based on the read gray scale value of each line area corresponding to the middle portion of the pattern; and calculates a second correction value, which is a correction value of the line area corresponding to an end portion of the pattern in the predetermined direction, based on the read gray scale value of the line area in the vicinity of the line area corresponding to the end portion of the pattern.

According to the program, it is possible to calculate the correction value for correcting the density irregularity of the line area where the margin is likely to have an influence on the result read by the scanner.

### First Embodiment

### Printing System

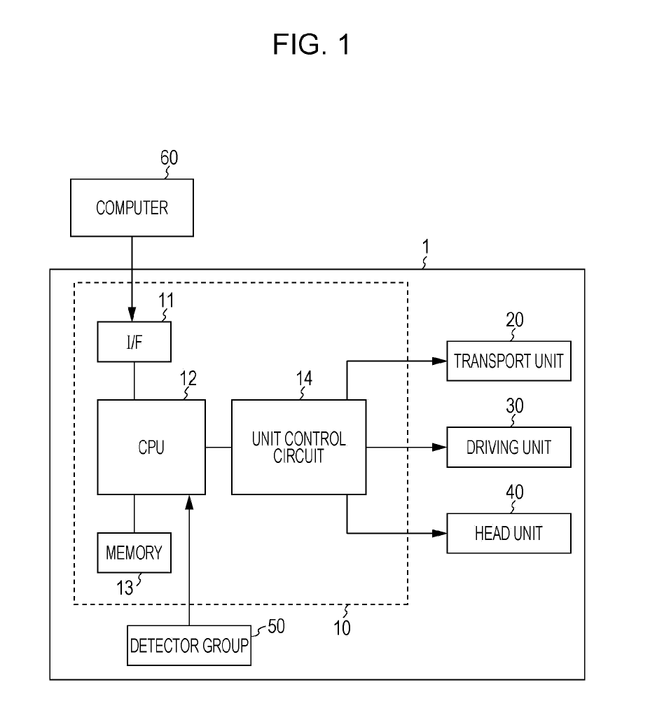

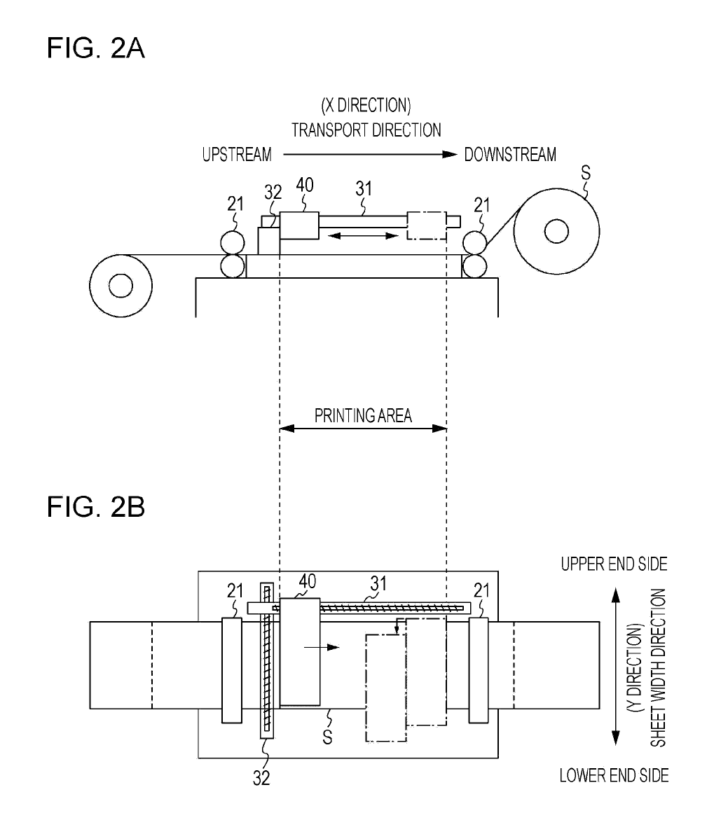

FIG. 1 is a block diagram illustrating the entire configuration of a printer 1. FIG. 2A is a schematic sectional view illustrating the printer 1. FIG. 2B is a schematic plan view illustrating the printer 1. Hereinafter, a printing system in which a printing apparatus is an ink jet printer (printer 1) and the printer 1 and a computer 60 are connected to each other will be described as an example according to embodiments.

A controller 10 is a control unit that controls the printer 1. An interface unit 11 is a unit that transmits and receives data between the computer 60 and the printer 1. A CPU 12 is an arithmetic processing unit that controls the entire printer 1. A memory 13 is a unit that ensures an area storing a program of the CPU 12, a working area, or the like. The CPU 12 controls each unit by a unit control circuit 14. A detector group 50 detects the internal status of the printer 1 and the controller 10 controls each unit based on a detection result obtained through the detection.

A transport unit 20 is a unit that transports a medium S from the upstream side to the downstream side in a direction (transport direction) in which the medium S (such as a roll sheet) is continuous. A transport roller 21 driven by a motor supplies a roll-shaped medium S not subjected to printing to a print area, and then a winding mechanism winds the medium S subjected to printing in a roll form. The medium S can be held at a predetermined position by adsorbing the medium S located at the print area in a vacuum manner from the lower side during printing.

A driving unit 30 moves the head unit 40 in an X direction (corresponding to an intersection direction) corresponding to the transport direction of the medium S and a Y direction (corresponding to a predetermined direction) corresponding to a sheet width direction of the medium S. The driving unit 30 includes an X-axis stage 31 moving the head unit 40 in the X direction, a Y-axis stage 32 moving the head unit 40 in the Y direction, and a motor (not shown) moving the X-axis stage 31 and the Y-axis stage 32.

The head unit 40 forms an image and includes a plurality of heads 41. A plurality of nozzles ejecting ink is formed on the lower surface of the head 41. Each of the nozzles is provided with a pressure chamber filled with ink. A method of ejecting ink from the nozzles may be a piezoelectric method of ejecting ink by applying a voltage to driving elements (piezoelectric elements) and expanding and contracting pressure chambers, or may be a thermal method of ejecting ink by generating bubbles in the nozzles with heating elements.

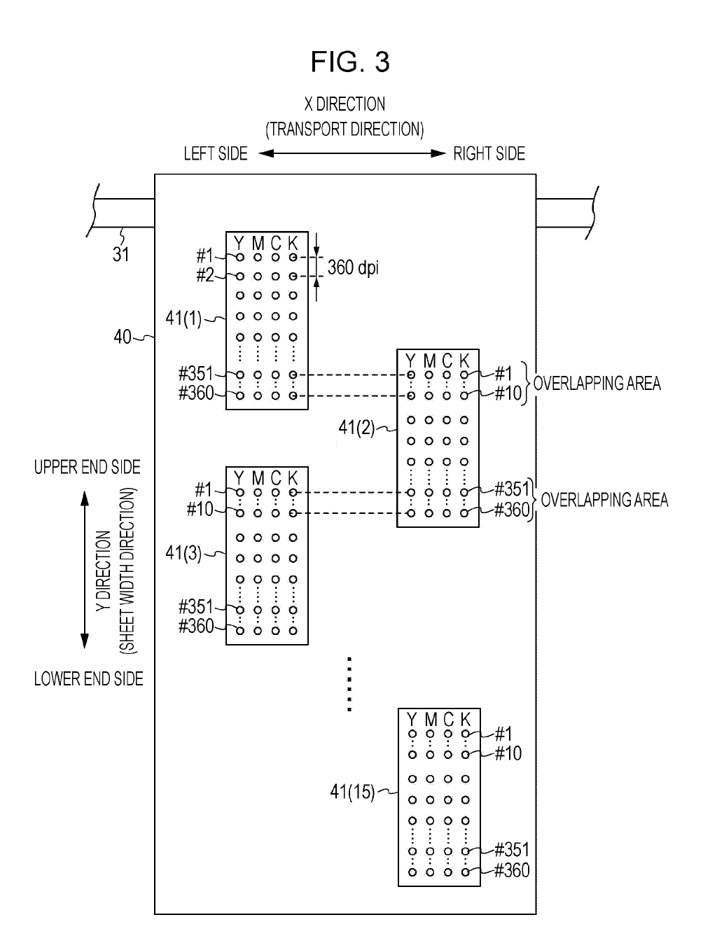

FIG. 3 is a diagram illustrating the arrangement of the plurality of heads 41 of the head unit 40. In FIG. 3, the arrangement of the heads 41 and the nozzles are viewed vertually from the upper surface of the head unit 40. Here, the head unit 40 includes fifteen heads 41(1) to 41(15). A yellow nozzle line Y ejecting yellow ink, a magenta nozzle line M ejecting magenta ink, a cyan nozzle line C ejecting cyan ink, and a black nozzle line K ejecting black ink are formed on the nozzle surface of each head 41. Each of the nozzle lines includes 360 nozzles. The 360 nozzles are arranged in the sheet width direction at a constant interval (360 dpi). As illustrated in FIG. 3, smaller numbers (positive integer numbers) are given to the nozzles in order from the nozzles on the upper end side in the sheet width direction (#1 to #360).

The plurality of heads 41 is arranged in a zigzag shape within the head unit 40 due to the difficulty of manufacturing. That is, the heads (for example, heads 41(1) and 41(2)) adjacent to each other in the sheet width direction are arranged to be deviated from each other in the transport direction. In the following description, the heads 41 are referred to as a 1st head 41(1), a 2nd head 41(2), and so on in order from the heads 41 from the upper end sides in the sheet width direction. Ten nozzles in the end portions of two heads (for example, the heads 41(1) and 41(2)) adjacent to each other in the sheet width direction overlap with each other. Therefore, in the head unit 40, the plurality of nozzles are lined up in the sheet width direction at the constant interval (360 dpi) along the entire width length of the head unit 40.

Next, a printing sequence will be described. First, the medium S is supplied to the print area by the transport unit 20. Then, an image formation process of ejecting ink from the nozzles while the X-axis stage 31 moves the head unit 40 in the X direction (transport direction of the medium) and a process of moving the head unit 40 toward the lower end side in the Y direction (sheet width direction) through the X-axis stage 31 by the Y-axis stage 32 are repeatedly performed. As a consequence, since dots can be formed in the subsequent image formation process at the positions different from those of the dots formed in the previous image formation process, a two-dimensional image can be printed on the medium S located in the print area. When the image is printed on the medium S located in the print area in this manner, a part of the medium not subjected to the printing is supplied to the print area by the transport unit 20 and an image is then printed on the medium located in the print area. In the following description, one performance of image formation process (which is a process of forming an image while moving the head unit 40 in the X direction) is referred to as a “pass”.

### Printing Method

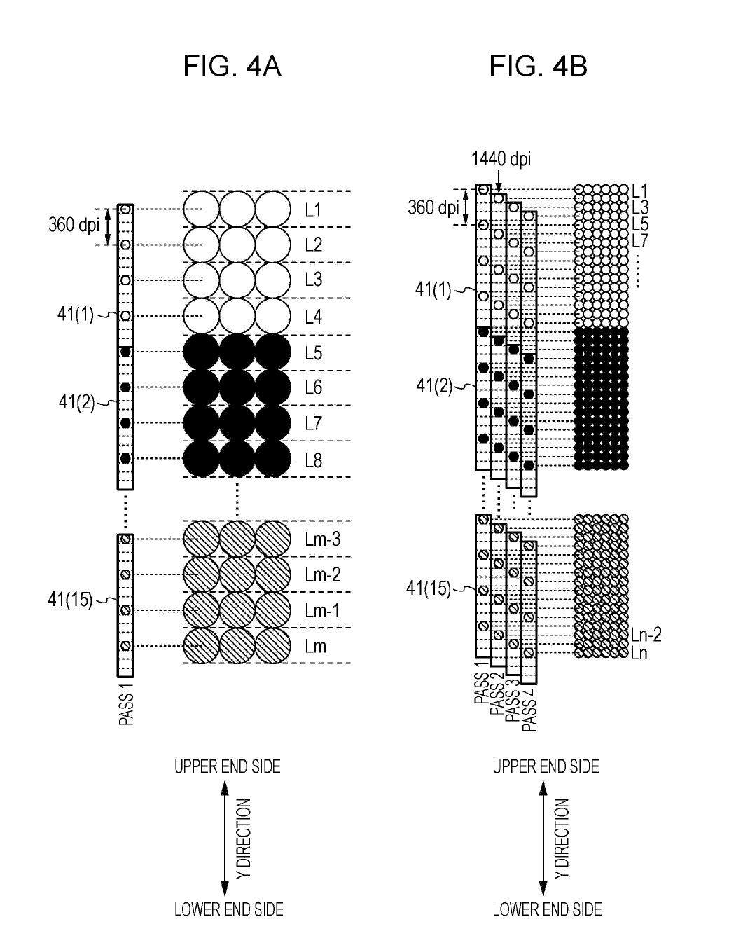

FIG. 4A is a diagram illustrating a printing method of completely printing an image by one pass. FIG. 4B is a diagram illustrating a printing method of completely printing an image by a plurality of passes. In the drawings, the reduced number of nozzles belonging to the heads 41 is illustrated. In the printer 1 according to this embodiment, as shown in FIG. 3, the nozzles in the end portions of the heads 41 overlap with each other, but in order to facilitate simple description, it is assumed below that one of the two nozzles overlapping with each other is used. A dot line formed in the X direction is referred to as a “raster line”. An area on the medium corresponding to a pixel forming image data, that is, a unit area on the medium where one dot is formed is referred to as a “pixel area”. A group of pixel areas lined up in the X direction is referred to as a “line area”. That is, one raster line is formed in one line area. Smaller numbers are given to the line areas forming an image in order from the line areas on the upper end side in the Y direction. For example, in FIG. 4, the uppermost end line area in the Y direction is referred to as a 1st line area and “L1” is given to the 1st line area. In the printer 1 according to this embodiment, as shown in FIG. 2B, the length of the head unit 40 in the Y direction is relatively longer than the sheet width of the medium S. Therefore, for example, when an image is printed on the medium S with a small sheet width or a small image is printed, an image can be completely printed without significantly moving the head unit 40 to the lower end side in the Y direction.

In FIG. 4A, a printing method in which a print resolution in the Y direction is relatively low is shown. When the print resolution in the Y direction corresponds to a nozzle pitch (360 dpi in FIG. 3), an image is completely printed by one pass, that is, by one performance of movement of the head unit 40 in the X direction. According to this printing method, the raster lines (white dot lines) are formed in the small number line areas on the upper end side in the Y direction by the 1st head 41(1), and the raster lines (diagonal dot lines) are formed in the large number line areas on the lower end side in the Y direction by the 15th head 41(15).

In FIG. 4B, a printing method in which a print resolution in the Y direction is relatively high is shown. When the print resolution in the Y direction corresponds to a fourfold nozzle pitch (1440 dpi), three raster lines are formed between the raster lines formed by the initial pass 1. Therefore, an image is completely printed by four passes and the head unit 40 is transported by a distance corresponding to 1440 dpi toward the lower end side in the Y direction between the passes. According to this printing method, as in the printing method of FIG. 4A, the raster lines are formed in the small number line areas on the upper end side in the Y direction by the 1st head 41(1), and the raster lines are formed in the large number line areas on the lower end side in the Y direction by the 15th head 41(15).

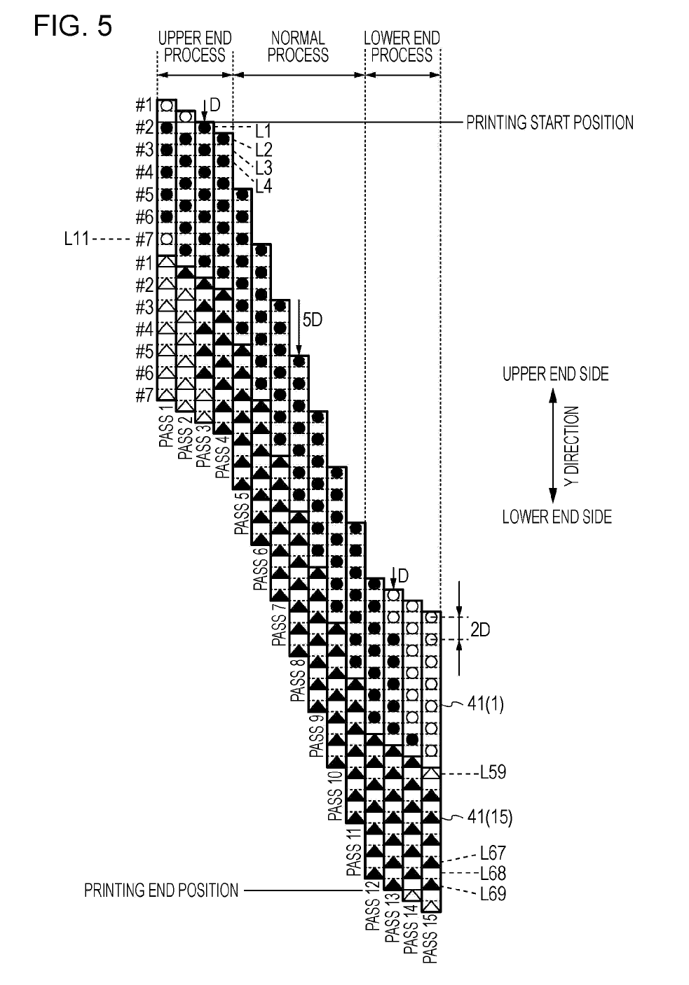

FIG. 5 is a diagram illustrating a printing method in which an upper end process, a normal process, and a lower end process are performed and transition of the heads 41 in each pass. In order to facilitate easy description, only the 1st head 41(1) on the uppermost end side in the Y direction and only the 15th head 41(15) on the lowermost end side in the Y direction are illustrated and the heads 41 between the 1st head 41(1) and the 15th head 41(15) are omitted. In addition, it is assumed that the number of nozzles belonging to each head 41 is seven. The nozzles of the 1st head 41(1) are indicated by a circle and the nozzles of the 15th head 41(15) are indicated by a triangle. The nozzles ejecting ink are depicted with black and the nozzles ejecting no ink are depicted with white. In FIG. 5, the print resolution in the Y direction is a double (720 dpi) of the nozzle pitch.

When printing starts and printing ends, the upper end process and the lower end process are performed in order to reduce the protrusion degree of the head unit 40 out of the medium. In FIG. 5, the length of one mass in the Y direction is D and a nozzle pitch corresponds to 2D. The transport amount of the head unit 40 in the normal process is 5D and the transport amount of the head unit 40 in the upper end process and the lower end process is D.

In the printing methods of FIGS. 4A and 4B, one nozzle can be assigned to one line area, and thus one raster line is formed by one nozzle. In the printing method of FIG. 5, however, the plurality of nozzles can be assigned to one line area, and thus one raster line is formed by the plurality of nozzles. Therefore, in the line areas (the middle line areas in the Y direction) printed in the normal process, one raster line is formed by the other heads 41.

However, the transport amount of the head unit 40 in the upper end process and the lower end process is shorter than the transport amount of the head unit 40 in the normal process. Therefore, in the printing method of FIG. 5, as in the printing methods of FIGS. 4A and 4B, the 1st head 41(1) forms the raster line in the line area printed in the upper end process, that is, the small number line area on the upper end side in the Y direction. In addition, the 15th head 41(15) forms the raster line in the large number line area on the lower end side in the Y direction.

### Density Irregularity

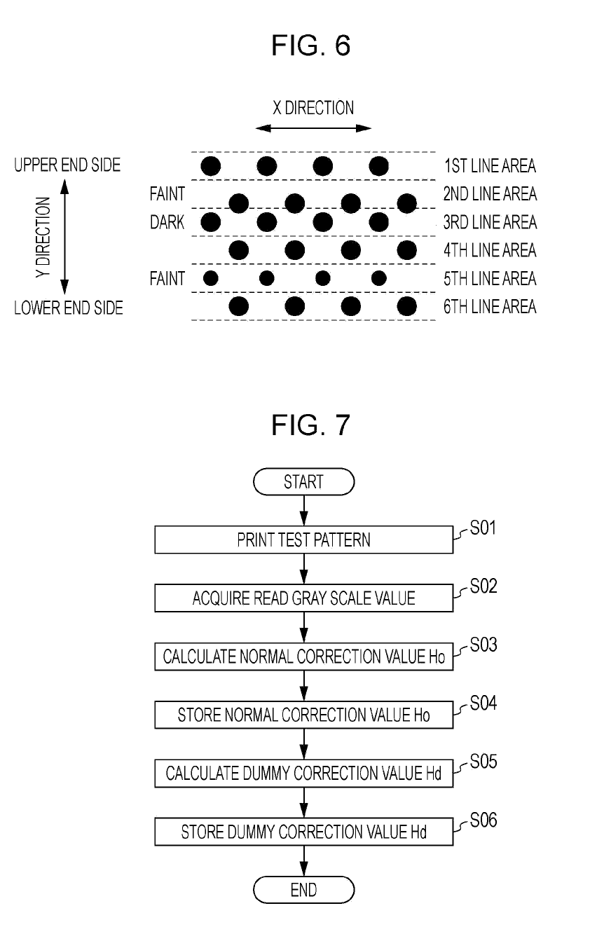

FIG. 6 is a diagram illustrating a cause of density irregularity. When a variation in the amount of ink ejected from the nozzles may occur due to a problem with processing precision of the nozzles or ink droplets ejected from the nozzles fly in a curved manner and are not landed on the appropriate positions, density irregularity occurs in an image.

In FIG. 6, for example, the raster line (dots) formed in the second line area is formed together in the third line area due to the fact that the ink droplets ejected from the nozzles fly in a curved manner. As a consequence, the second line area appears faint and the 3rd line area appears dark. On the other hand, the ink amount of the ink droplets ejected toward the 5th line area is smaller than a defined amount and the dots formed in the 5th line area become small. As a consequence, the 5th line area becomes faint. Due to these problems, density irregularity occurs in an image. Therefore, the density irregularity can be suppressed by performing correction so that the line area printed faintly is printed darkly and by performing correction so that the line area printed darkly is printed faintly.

In this case, the reason why the density of the third line area is dark is that the nozzles allocated to the third line area have no influence on the density but the nozzles allocated to the adjacent second line area have an influence on the density. Therefore, when the nozzles allocated to the third line area form a raster line in another line area, the image pieces formed in the line area do not necessarily become dark. That is, even the image pieces formed by the same nozzles may have different densities when the nozzles forming the adjacent image piece are different. In this case, the density irregularity may not be suppressed with the correction values merely corresponding to the nozzles. In this embodiment, however, a correction value H for suppressing the density irregularity is set in every line area. Since the degree of the density irregularity is also different due to the print density, a correction value H for suppressing the density irregularity is also set for each density (each gray scale value indicating the density).

### Calculating Correction Value H of Density Irregularity

FIG. 7 is a flowchart illustrating the calculation of the correction value H for the density irregularity. The correction value H for the density irregularity in each line area is calculated for every printer 1 when the printer 1 is manufactured or maintenance is performed. Here, it is assumed that the correction value H is calculated according to a “correction value acquiring program (corresponding to a program)” installed in a computer connected to the printer 1 for which the correction value H is calculated. The correction value acquiring program may be recorded in a recording medium (computer readable recording medium) such as a CD-ROM, or may be downloaded to a computer via the Internet. The correction value acquiring program executes the following processes using the hardware resources of the computer.

### S01: Printing Test Pattern

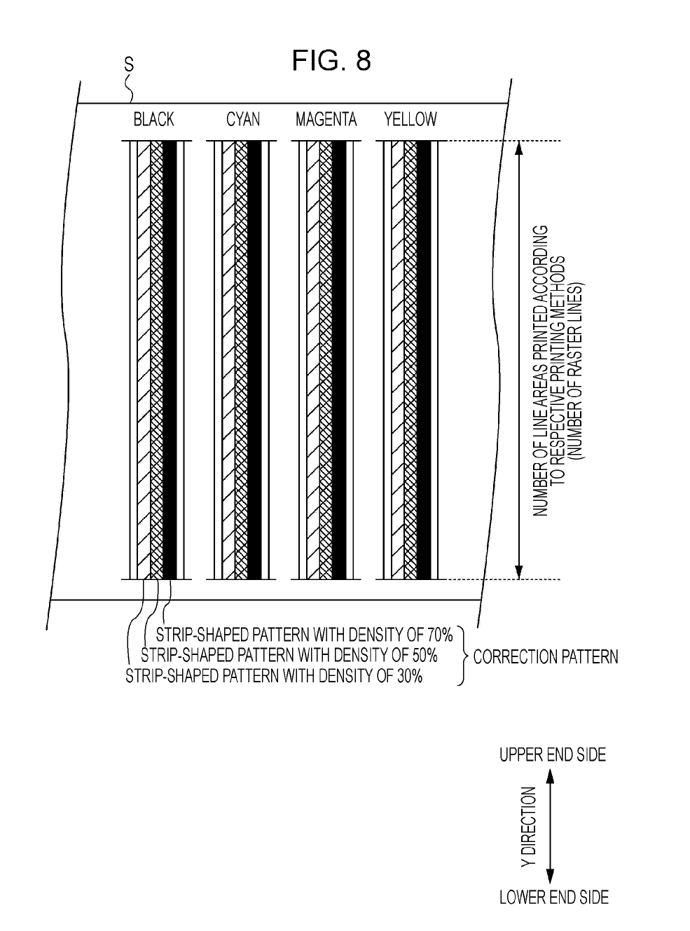

FIG. 8 is a diagram illustrating a test pattern. The correction value acquiring program first causes the printer 1, for which the correction value H is calculated, to print the test pattern. The test pattern includes four correction patterns formed with ink colors, that is, nozzle lines (YMCK), respectively. One correction pattern includes three kinds of strip-shaped densities. The strip-shaped patterns are formed from the image data of the respective constant gray scale values. The gray scale value used to form the strip-shaped pattern is referred to as an instruction gray scale value. An instruction gray scale value of the strip-shaped pattern with density of 30% is denoted by Sa(76), an instruction gray scale value of the strip-shaped pattern with density of 50% is denoted by Sb(128), and an instruction gray scale value of the strip-shaped pattern with density of 70% is denoted by Sc(179). A higher gray scale value indicates darker density and a lower gray scale value indicates fainter density.

As shown in FIGS. 4A, 4B, and 5, the number of line areas forming an image or the nozzles allocated to the respective line areas are different depending on the printing method. Here, the correction value acquiring program calculates the correction value H for the density irregularity according to each printing method performed by the printer 1. Therefore, the correction value acquiring program causes the printer 1 to print the test pattern according to each printing method performed by the printer 1. For example, when the test pattern is printed according to the printing method of FIG. 4B, the test pattern is completely printed by four passes. The correction pattern includes n raster lines (line areas). In the printing method of FIG. 5, the number of passes in the normal process is changed depending on the size of the medium or the like. In the normal process, there is regularity in which the nozzles can be allocated to the predetermined number of line areas. Here, the correction pattern includes at least a predetermined number of line areas in which there is the regularity in the normal process.

### S02: Acquiring Read Gray Scale Values

A scanner is connected to the computer in which the correction value acquiring program is installed (however, the invention is not limited thereto when the printer 1 has the function of a scanner). After an examiner sets the medium S on which the test patterns are printed in the scanner, the correction value acquiring program (or a scanner driver) causes the scanner to read the test pattern on the set medium. Thereafter, the correction value acquiring program acquires the read result of the test patterns. When the image of the test pattern is inclined on the read data, the slope of the image may be corrected by detecting the slope θ of the image and performing a rotation process. Hereinafter, the area corresponding to the “pixel area” which is a unit area, where one dot is formed on a medium, on the read data is referred to as a “pixel”. The area corresponding to the “line area” where the pixel areas are lined up in the X direction is referred to as a “pixel line”.

For example, when the test pattern is read at a resolution higher than the print resolution of the test pattern in the Y direction, the number of pixel lines on the read data is greater than the number (the number of raster lines) of line areas of the correction pattern. In this case, in the correction value acquiring program, it is configured such that the number of line areas of the correction pattern is the same as the number of pixel lines on the read data, and the line areas of the correction pattern and the pixel lines on the read data correspond to each other one-to-one.

After the line areas of the correction pattern and the pixel lines on the read data correspond to each other one-to-one, the correction value acquiring program calculates the read gray scale value (density) of each of the line areas (L1 and so on) for each of the strip-shaped patterns (30%, 50%, and 70%) of each ink (YMCK). Specifically, the correction value acquiring program calculates the average values of the read gray scale values of the pixels belonging to the pixel line corresponding to a given color, a given strip-shaped pattern, and a given line area, as “read gray scale values (densities)” of the given color, the given strip-shaped pattern, and the given line area. A higher read gray scale value read by the scanner indicates darker density and a lower read gray scale value indicates fainter density.

### Correction Value Calculating Method According to Comparative Example

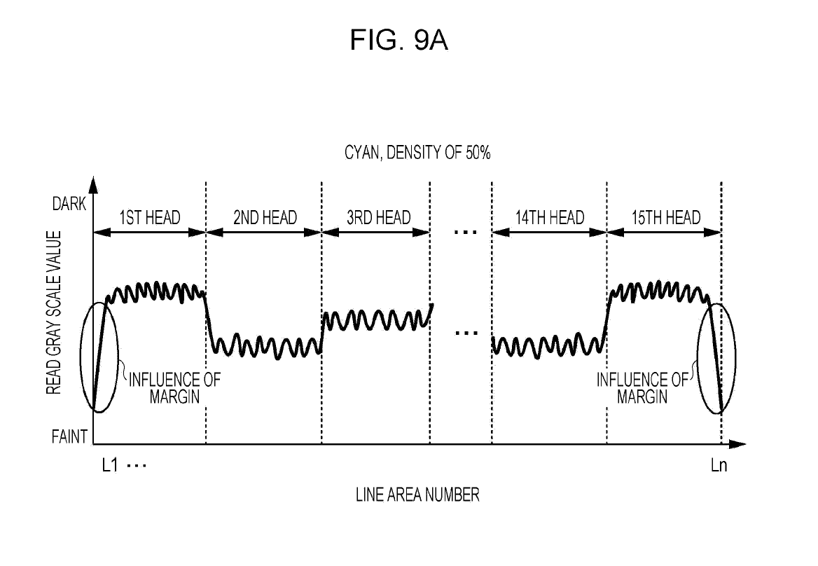

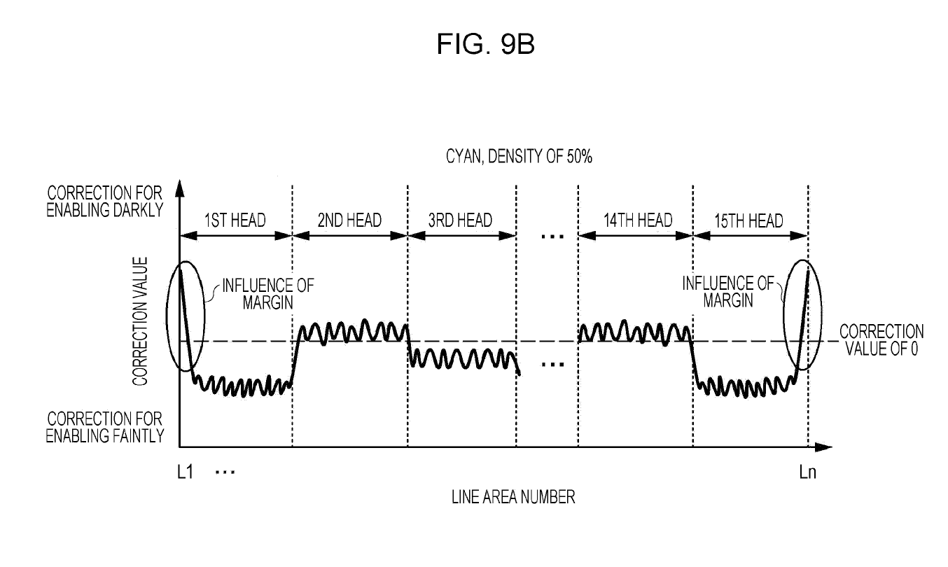

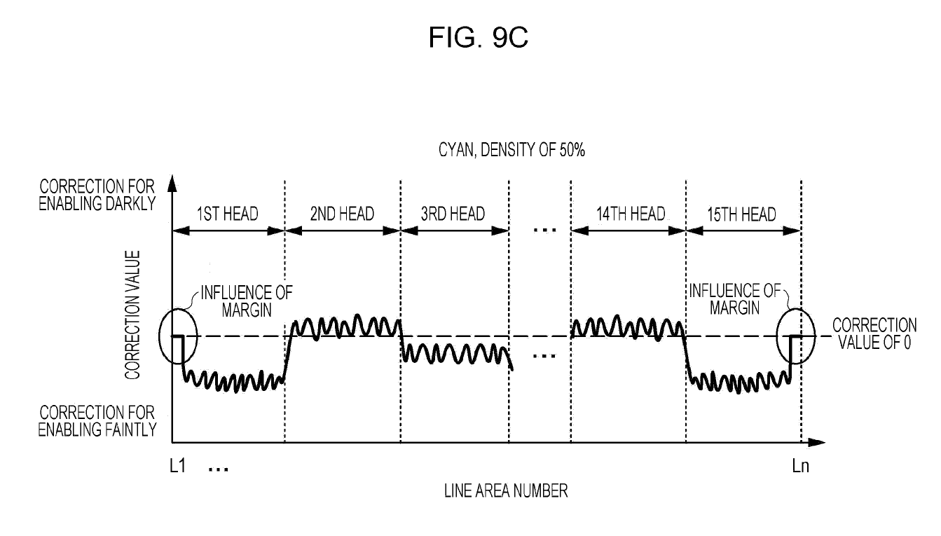

FIG. 9A is a diagram illustrating the result obtained by reading the strip-shaped pattern with density of 50% for cyan among the test patterns printed by the printing method of FIG. 4B by the scanner. FIGS. 9B and 9C are diagrams illustrating a correction value calculating method according to a comparative example. Hereinafter, the method of calculating the correction value H for the density irregularity will be described, for example, in the strip-shaped pattern with density of 50% for cyan printed by the printing method of FIG. 4B. In the graph of FIG. 9A, the horizontal axis represents a line area number and the vertical axis represents a read gray scale value. Since the test pattern is printed by the printing method of FIG. 4B, the line areas of the correction pattern (strip-shaped pattern) include a 1st line area to an n-th line area. The line areas are printed in order from the line areas with smaller numbers by the heads 41 with the smaller numbers, as shown in FIG. 9A.

In the strip-shaped pattern with density of 50%, a variation occurs in the read gray scale values of the respective line areas regardless of the fact that the line areas are formed uniformly with the instruction gray scale value Sb. The variation in the read gray scale values of the respective line areas causes the density irregularity in a printed image. The printer 1 according to this embodiment includes fifteen heads 41. A variation also occurs in the printing characteristics of the respective heads 41 due to a manufacturing error, an installation error, or the like of the heads 41. In FIG. 9A, for example, the density of an image printed by the 1st head 41(1) appears relatively dark and the density of an image printed by the 2nd head 41(2) appears relatively faint. Accordingly, the density irregularity is caused by not only the variation in the ink ejection characteristics of the respective nozzles but also the variation of the printing characteristics of the respective heads 41.

FIG. 9B is the diagram illustrating the graph showing the correction values for the density irregularity calculated by the correction value calculating method according to the comparative example. The horizontal axis represents a line area number and the vertical axis represents a correction value. The density of the image is corrected to be darker as the correction value is larger (positive value), and the density of the image is corrected to be fainter as the correction value is smaller (negative value). For example, as shown in FIG. 9A, the image printed by the 1st head 41(1) is printed more darkly than the image printed by the other heads 41. Therefore, as shown in FIG. 9B, the correction value of the line area allocated to the 1st head 41(1) becomes a small value (which is a correction value for correcting the density faintly). On the other hand, the image printed by the 2nd head 41(2) is printed more faintly than the image printed by the other heads 41. Therefore, the correction value of the line area allocated to the 2nd head 41(2) is a large value (which is a correction value for correcting the density darkly). As a consequence, the density of the image printed by the 1st head 41(1) is corrected so as to be fainter, whereas the density of the image printed by the 2nd head 41(2) is corrected so as to be darker. Accordingly, the density irregularity is suppressed.

The line areas corresponding to the upper and lower end portions of the correction pattern (see FIG. 8) in the Y direction are close to the margins of the medium on which the test pattern is printed. Therefore, when the correction pattern is read by the scanner, the ground color of the medium has an influence on the line areas corresponding to the upper and lower end portions of the correction pattern in the Y direction. When the ground color (base color) is white, a problem may arise in that the density of the line areas close to the margins of the medium is read more faintly than the actual density. As shown in FIG. 9A, the read gray scale values of the small number line areas corresponding to the upper end portion and the read gray scale values of the large number line areas corresponding to the lower end portion are smaller values (faint values) than the read gray scale values of the near line areas thereof.

In the correction value calculating method according to the comparative example in FIG. 9B, the correction values of the line areas on which the margins have an influence are calculated based on the read gray scale values of the line areas on which the margins have an influence. As a consequence, as shown in FIG. 9B, the correction values (which are correction values surrounded by a line) of the line areas on which the margins have an influence become a large value, that is, a correction value for correcting the density of the image darkly. The images printed by the 1st head 41(1) and the 15th head 41(15) are printed more darkly than the images printed by the other heads 41. Therefore, in effect, both the line area printed by the 1st head 41(1) and corresponding to the upper end portion and the line area printed by the 15th head 41(15) and corresponding to the lower end portion are printed darkly. However, in the read results (read gray scale values) of the line areas corresponding to the upper and lower end portions, the densities of these line areas are read more faintly than the actual density due to the influence of the margins. Therefore, the density irregularity may not be suppressed with the correction values calculated based on the read results that the densities are read faintly.

That is, the read gray scale values of the line areas on which the margins have an influence are not the appropriate read results of the line areas corresponding to the upper and lower end portions. Therefore, the density irregularity may not be suppressed even when the correction values are calculated based on the read gray scale values which are not the appropriate read results. In particular, as in FIG. 9B, in effect, the line areas corresponding to the upper and lower end portions are printed darkly. Therefore, the density irregularity may deteriorate when the correction values used to correct the line areas darkly are calculated under the influence of the margins. Moreover, the line areas corresponding to the upper and lower end portions are corrected more darkly, whereas the near line areas thereof, that is, the other line areas printed by the 1st head 41(1) and the 15th head 41(15) are corrected faintly. Therefore, the boundary between the line areas on which the margins have an influence and the line areas on which the margins have no influence are visibly noticeable, thereby deteriorating image quality.

In the correction value calculating method according to the comparative example in FIG. 9C, the correction value of the line areas on which the margins have an influence is set to 0. That is, no density correction is performed on the line areas on which the margins have an influence. In this case, as in the correction values shown in FIG. 9B, the density irregularity can be suppressed from deteriorating by performing reverse correction on the line areas on which the margins have an influence. However, the line areas on which the margins have no influence are corrected so that the image with a constant density is printed, whereas the densities of the line areas on which the margins have an influence are not corrected. Therefore, the density irregularity in the upper and lower end portions of the image remains unsolved.

In the printer 1 including the plurality of heads 41, the density difference occurs in the image printed by each head 41 due to the difference in the characteristics of the heads 41. The density difference occurring in the heads 41 has a tendency to be larger than the density difference occurring in the respective nozzles of the same head 41. As shown in FIG. 9A, for example, the read gray scale values of the images printed by the 2nd head 41(2) to the 14th head 41(14) are relatively close to each other. However, the read gray scale values of the images printed by the 1st head 41(1) and the 15th head 41(15) are relatively distant values from the read gray scale values of the images printed by the other heads 41(2) to 41(14). The average value of the read gray scale values of all the heads 41(1) to 41(15) is set to a target value, and the correction values are calculated so that the densities of the images printed by the heads 41 become the target value. In this case, the correction amounts of the 1st head 41(1) and the 15th head 41(15) are larger than the correction amounts of the other heads 41. Since only the line areas on which the margins have an influence are not corrected among the line areas printed by the 1st head 41(1) and the 15th head 41(15), the density difference becomes larger than that of the other line areas. As a consequence, the density difference in the boundary between the line areas on which the margins have an influence and the line areas on which the margins have no influence is visibly noticeable, thereby deteriorating image quality.

The invention is not limited to the case where the average value of the read gray scale values of all the heads 41(1) to 41(15) is set to a target value, but the correction values may be calculated so that the instruction gray scale value (Sb in FIG. 9) obtained in the printing of the correction pattern is set as a target value. For example, the read gray scale values of the 1st head 41(1) and the 15th head 41(15) are values distant from the instruction gray scale values. Even in this case, the correction amount of the 1st head 41(1) and the 15th head 41(15) are larger than the correction amounts of the other heads 41. However, since the line areas on which the margins have an influence are not corrected, the density difference in the boundary between the line areas on which the margins have an influence and the line areas on which the margins have no influence is visibly noticeable, thereby deteriorating image quality.

In this embodiment, however, the boundary can barely visibly noticeable by resolving the density difference between the line areas on which the margins of the medium on which the test patterns are printed have an influence and the line areas on which the margins of the medium have no influence. In other words, the image quality can be prevented from deteriorating by resolving the density irregularity in the entire areas of the image.

### Correction Value Calculating Method According to Embodiment

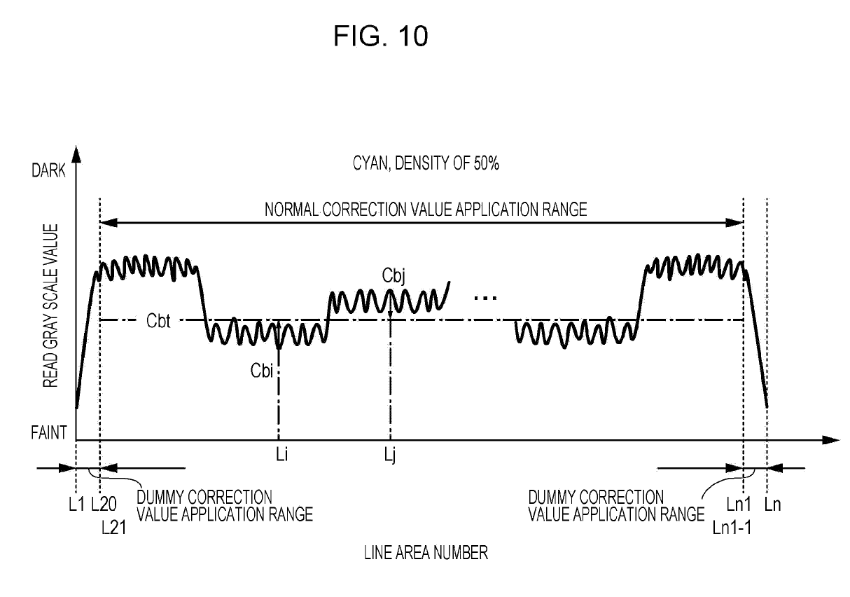

FIG. 10 is a diagram illustrating an application range of a normal correction value Ho and an application range of a dummy correction value Hd. As in the graph of FIG. 9A, the graph of FIG. 10 shows the result obtained by reading the strip-shaped pattern with density of 50% for cyan by the scanner. The read gray scale value of the small number lines area corresponding to the upper end portion of the correction pattern and the read gray scale value of the large number line area corresponding to the lower end portion of the correction pattern are read with the fainter density than the actual density under the influence of the margins of the medium on which the test pattern is printed. In this embodiment, the correction values of the line areas on which the margins have an influence are calculated based on the correction values of the near line areas thereof.

In FIG. 10, it is assumed that the line areas of the upper end portion on which the margin has an influence are the 1st line area to the 20th line area (L1 to L20) and the line areas of the lower end portion on which the margin has an influence are the n1-th line area to the n-th line area (Ln1 to Ln). A correction value (hereinafter, referred to as a “dummy correction value Hd (corresponding to a second correction value)) calculated based on the correction values of the other near line area thereof is applied to the line area on which the margin has an influence. The range of the line areas to which the dummy correction Hd is applied is referred to as a “dummy correction value application range”. The line areas belonging to the dummy correction value application range correspond to the line areas corresponding to the end portions of the correction pattern in the Y direction. A correction value (hereinafter, referred to as a “normal correction value Ho (corresponding to a first correction value)) calculated based on the read gray scale value of each line area is applied to the line area on which the margin has no influence, that is, the line area out of the dummy correction value application range. The range of the line areas to which the normal correction value Ho is applied is referred to as a “normal correction value application range”. The line areas belonging to the normal correction value application range correspond to the line areas corresponding to the middle portion of the correction pattern in the Y direction. That is, in FIG. 10, the range (L21 to Ln1-1) from the 21st line area to the n1−1-th line area is the “normal correction value application range”. Here, the number of line areas on which the margin has an influence is twenty, but the invention is not limited thereto.

### S03: Calculating Normal Correction Value Ho

The correction value acquiring program causes the printer 1 to print the test patterns, to acquire the read gray scale values (for example, FIG. 10) obtained when the scanner reads the test patterns, and then to calculate the normal correction value Ho for each of the line areas belonging to the normal correction value application range. For example, in the graph of FIG. 10 which is the read result of the strip-shaped pattern of density of 50% for cyan, the i-th line area Li appears fainter than that the other line areas and the j-th line area Lj appears darker than other line areas. The density irregularity is caused by the variation in the read scale value for each line area. Accordingly, the density irregularity in the normal correction value application range can be suppressed by approximating the density of the image piece formed in each of the line areas belonging to the normal correction value application range to a given value.

By the correction value acquiring program, the average value of the read gray scale values of the line areas (L21 to Ln1-1) belonging to the normal correction value application range is calculated for each color (YMCK) and for each instruction gray scale value (Sa, Sb, Sc), and this average value is set as a target value of the density correction. For example, it is assumed that the average value of the read gray scale values of the line areas belonging to the normal correction value application range among the line areas of the strip-shaped pattern of density of 50% for cyan is “Cbt”. In this case, the correction value acquiring program calculates the correction value to be used to correct the instruction gray scale value Sb so that the density (read gray scale value) of the image piece printed in each line area with the instruction gray scale value Sb approximates the target value (average value) Cbt.

As shown in FIG. 10, for example, the gray scale value indicating the pixels corresponding to the i-th line area with the read gray scale value lower than that the target value Cbt is corrected to the gray scale value darker than the instruction gray scale value Sb. In contrast, the gray scale value indicating the pixels corresponding to the j-th line area with the read gray scale value higher than the target value Cbt is corrected to the gray scale value fainter than the instruction gray scale value Sb.

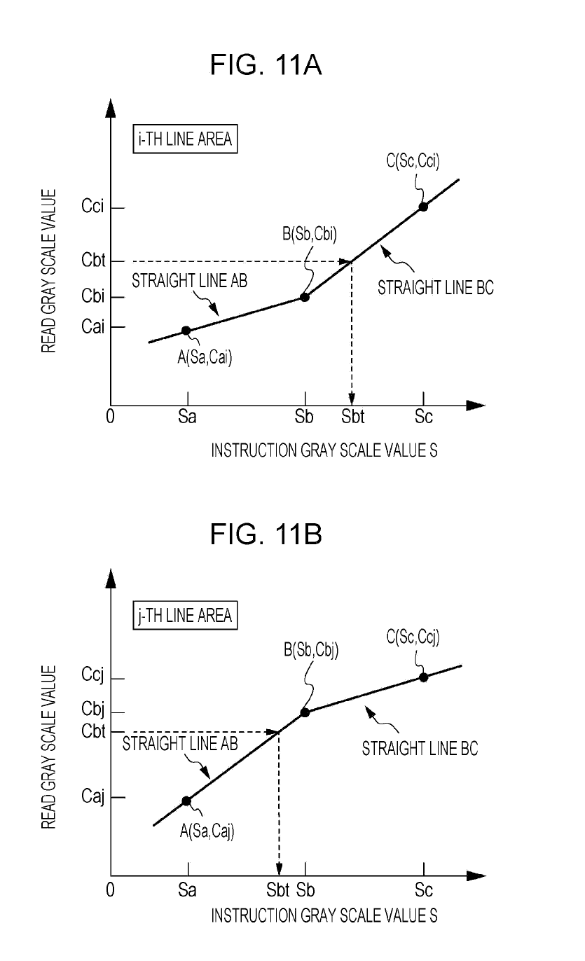

FIGS. 11A and 11B are diagrams illustrating specific methods of calculating the normal correction value Ho. In FIG. 11A, a target instruction gray scale value (Sbt) for the instruction gray scale value (Sb) is calculated in the i-th line area with the read gray scale value lower than the target value Cbt. The horizontal axis represents the gray scale value and the vertical axis represents the read gray scale value of the i-th line area. In the graph, read gray scale values (Cai, Cbi, and Cci) are plotted for the instruction gray scale values (Sa, Sb, and Sc). The target instruction gray scale value Sbt for the instruction gray scale value Sb is calculated by the following expression (linear interpolation based on a straight line BC) so that the i-th line area is indicated by the target value Cbt.

Sbt=Sb+{(Sc−Sb)×(Cbt−Cbi)/(Cci−Cbi)}

In the j-th line area with the read gray scale value higher than the target value Cbt, as shown in FIG. 11B, the target instruction gray scale value Sbt for the instruction gray scale value Sb is calculated by the following expression (linear interpolation based on the straight line AB) so that the j-th line area is indicated with the target value Cbt.

Sbt=Sa+{(Sb−Sa)×(Cbt−Caj)/(Cbj−Caj)}

Thus, the target instruction gray scale value Sbt for the instruction gray scale value Sb in each line area is calculated. Thereafter, the correction value acquiring program calculates a normal correction value Ho(b) of cyan for the instruction gray scale value Sb in each of the line areas belonging to the normal correction value application range by the following expression. Likewise, the correction value acquiring program calculates the normal correction values Ho for the other instruction gray scale values (Sa, Sc) and the normal correction values Ho of the other colors (yellow, magenta, and black).

Ho(b)=(Sbt−Sb)/Sb

### S04: Storing Normal Correction Value Ho

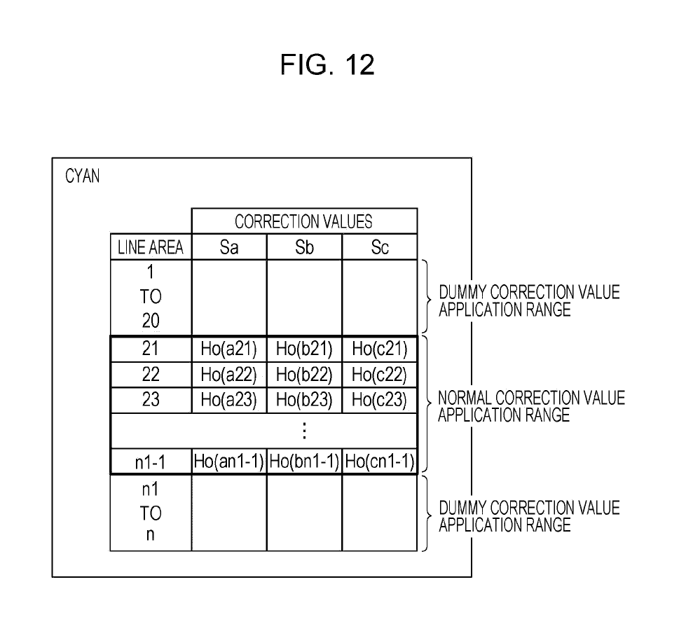

FIG. 12 is a diagram illustrating a correction value table. The correction value acquiring program calculates the normal correction values Ho of the line areas belonging to the normal correction value application range, and then stores the calculated normal correction values Ho in the correction value table. The normal correction values (Ho(a), Ho(b), and Ho(c)) respectively corresponding to the three instruction gray scale values (Sa, Sb, and Sc) for each line area are stored in the correction value table. In this step, only the correction values Ho corresponding to the line areas (L21 to Ln1-1) belonging to the normal correction value application range are stored, but the correction values Hd corresponding to the line areas (L1 to L20, Ln1 to Ln) belonging to the dummy correction value application range are not stored. When there is regularity in the predetermined number of line areas in the normal process, as in the printing method of FIG. 5, the correction values of the number corresponding to the predetermined number of line areas may be stored.

### S05: Calculating Dummy Correction Value Hd

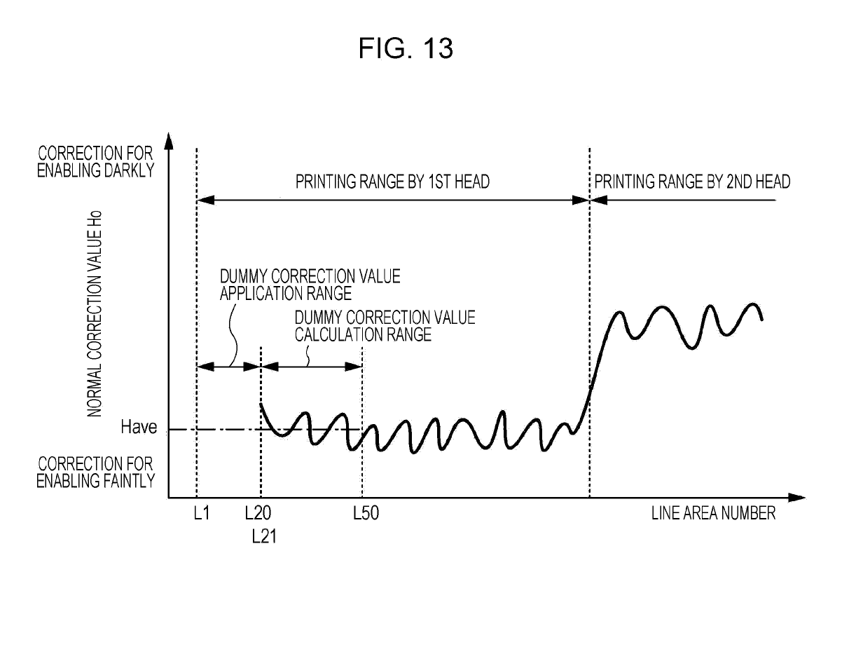

FIG. 13 is a diagram illustrating a calculation range of the dummy correction value Hd. In FIG. 13, the graph shows the normal correction values Ho(b) of the instruction gray scale values Sb of cyan. The horizontal axis represents a line area number and the vertical axis represents the normal correction value Ho. Hereinafter, the line areas (L1 to L20) belonging to the dummy correction value application range on the upper end side in the Y direction will be described as an example. In this embodiment, the dummy correction values Hd of the line areas belonging to the dummy correction value application range are calculated based on the normal correction values Ho of the other near line areas in the dummy correction value application range. A common dummy correction value Hd(u) is applied to the line areas belonging to the dummy correction value application range on the upper end side. A common dummy correction value Hd(1) is applied to the line areas belonging to the dummy correction value application range on the lower end side. The range of the line areas used to calculate the dummy correction values Hd is referred to as a “dummy correction value calculation range”. The line areas belonging to the dummy correction value calculation range correspond to the line areas used to calculate the dummy correction values and correspond to the near line areas of the line areas (the lines areas belonging to the dummy correction value application range) corresponding to the end portions of the correction pattern. In FIG. 13, it is assumed that the 21st line area to the 50th line area belong to the dummy correction value calculation range. The correction value acquiring program stores the dummy correction value application range or the dummy correction value calculation range as a parameter.

In order to calculate a dummy correction value Hd(bu) for the instruction gray scale value Sb on the upper end side, the correction value acquiring program first acquires the normal correction values (Ho(b21) to Ho(b50)) for the instruction gray scale value Sb of the line areas belonging to the dummy correction value calculation range with reference to the correction value table of FIG. 12. Next, the correction value acquiring program calculates an average value Have of the acquired normal correction values Ho (calculates Have={Ho(b21)+Ho(b22)+ . . . +Ho(b50)}/30). The calculated average value Have is the dummy correction value Hd(bu) for the instruction gray scale value Sb on the upper end side. Likewise, the correction value acquiring program also calculates dummy correction values Hd(au) and Hd(cu) for the other instruction gray scale values Sa and Sc on the upper end side, respectively. Although not shown, it is assumed that the dummy correction value calculation range on the lower end side includes, for example, the n1−30-th line area to the n1−1-th line area. In this case, the correction value acquiring program calculates the average value of the normal correction values Hd of the n1−30-th line area to the n1−1-th line area as the dummy correction value Hd for each instruction gray scale value.

That is, in this embodiment, the other line areas (for example, L21 to L50) in the vicinity of the dummy correction value application range (for example, L1 to L20) are set as the dummy correction value calculation range. The average of the normal correction values Ho of the line areas belonging to the dummy correction value calculation range is calculated as the dummy correction value Hd.

As shown in FIG. 9A described above, the variation occurs in the density of the image printed by each head 41 due to the characteristic difference of each head 41. In FIG. 9A, the density of the image printed by the 1st head 41(1) is higher than those of the images printed by the other heads 41. Therefore, it is necessary to correct the line area printed by the 1st head 41(1) faintly. Since the line areas (L1 to L20) in the dummy correction value application range on the upper end side are printed by the 1st head 41(1), it is necessary to correct the dummy correction value Hd to a correction value for enabling the density of the image to be faint. In this embodiment, the other line areas in the vicinity of the dummy correction value application range are set to the dummy correction value calculation range. Therefore, the line areas (L21 to L50) in the dummy correction value calculation range are also the line areas printed by the 1st head 41(1) and the normal correction values Ho of the line areas in the dummy correction value calculation range are the correction values for enabling the density of the image to be faint. Therefore, the dummy correction value Hd becomes the correction value for enabling the density of the image to be faint. Thus, the line areas printed darkly by the 1st head 41(1) among the line areas (L1 to L20) in the dummy correction value application range are corrected faintly by the dummy correction values Hd. As a consequence, the density irregularity between the line areas in the dummy correction value application range and the other line areas can be suppressed.

The printer 1 according to this embodiment performs the printing methods shown in FIGS. 4A, 4B, and 5. In either printing method, the plurality of smaller number line areas on the upper end side in the Y direction are printed by the 1st head 41(1) and the plurality of large number line areas on the lower end side in the Y direction are printed by the 15th head 41(15). Therefore, when the test patterns are read by the scanner, the line areas on the upper end side on which the margin has an influence are printed by the 1st head 41(1). Accordingly, the dummy correction value calculation range on the upper end side may include the line areas printed by the 1st head 41(1). On the other hand, since the line areas on the lower end side on which the margin has an influence are printed by the 15th head 41(15), the dummy correction value calculation range on the lower end side may include the line areas printed by the 15th head 41(15).

That is, by setting the heads 41 printing the line areas belonging to the dummy correction value application range to be the same as the heads 41 printing the line areas belonging to the dummy correction value calculation range, the correction values can be calculated according to the characteristics of the heads 41 printing the line areas belonging to the dummy correction value application range, thereby suppressing the density irregularity. Both the line areas (for example, L1 to L20) belonging to the dummy correction value application range and the line areas (for example, L21 to L50) belonging to the dummy correction value calculation range in the vicinity of the line areas are printed with the same density (for example, printed darkly), but are corrected to the same degree (for example, corrected faintly). Therefore, the boundaries between the line area (the line areas in the dummy correction value application range) on which the margins have an influence and the line areas on which the margins have no influence are barely visibly noticeable. In other words, the line areas printed by the heads 41 printing the line areas in the dummy correction value application range and the other heads 41 do not belong to the dummy correction value calculation range. Thus, the dummy correction values Hd can be more reliably calculated according to the characteristics of the heads 41 printing the line areas in the dummy correction value application range.

In order to set the heads 41 printing the line areas belonging to the dummy correction value application range and printing the line areas belonging to the dummy correction value calculation range to be same as each other, the line areas located in the areas with the length corresponding to nearly one head from the printing start position may be set as the line areas in the dummy correction value calculation range. Specifically, the line areas belonging to the dummy correction value calculation range on the upper end side may be set as the small number line areas on the upper end side up to the line area allocated to the lowermost end nozzle of the 1st head 41(1) at the initial pass 1. Moreover, when both two nozzles (for example, the nozzle #351 of the 1st head 41(1) and the nozzle #1 of the 2nd head 41(2)) overlapping with each other are used, the lowermost end nozzle of the 1st head 41(1) at pass 1 is the lowermost end nozzle among the nozzles which do not overlap with each other. On the other hand, the line areas belonging to the dummy correction value calculation range on the lower end side may be set as the large number line areas on the lower end side among the line areas allocated to the uppermost end nozzle of the 15th head 41(15) at the final pass. For example, in the printing method of FIG. 5, the line areas up to the line area L11 allocated to the lowermost end nozzle #7 of the 1st head 41(1) at pass 1 may be set as the line areas in the dummy correction value calculation range on the upper end side. On the other hand, the line areas after the line area L59 allocated to the uppermost end nozzle #1 of the 15th head 41(15) at the final pass 15 may be set as the line areas in the dummy correction value calculation range on the lower end side.

In the example of FIG. 13, the line areas in the dummy correction value application range are the line areas up to the 20th line area and the line areas from the 21st line area fall in the dummy correction value calculation range. In addition, the line areas in the dummy correction value application range and the line areas in the dummy correction value calculation range are adjacent to each other. However, the invention is not limited thereto. When the heads 41 printing the line areas belonging to the dummy correction value application range and printing the line areas belonging to the dummy correction value calculation range are the same as each other, the line areas in the dummy correction value application range and the line areas in the dummy correction value calculation range may be distant from each other.

In the example of FIG. 13, the dummy correction value calculation range (L21 to L50) does not include the dummy correction value application range (L1 to L20), but the invention is not limited thereto. The dummy correction value calculation range may include the line areas in the dummy correction value application range. For example, when the dummy correction value calculation range includes the line areas on which the margin has a small influence among the line areas in the dummy correction value application range, the characteristics of the heads 41 actually printing the line areas are added to the correction values which are applied to the line areas on which the margin has the influence. However, it is desirable that the dummy correction value calculation range does preferably include the dummy correction value application range. The method of calculating the dummy correction value Hd based on the correction value of the line area on which the margin has no influence can more reliably suppress the density difference between the line area on which the margin has an influence and the line area on which the margin has no influence.

In the example of FIG. 13, the number of line areas belonging to the dummy correction value calculation range is thirty, but the invention is not limited thereto. The number of line areas belonging to the dummy correction value calculation range may be, for example, twenty or one. However, there is the characteristic difference in every nozzle even when the nozzles are included in the same head 41. Therefore, as shown in FIG. 9A, the variation occurs in the densities (read gray scale value) of the image pieces printed by the other nozzles. Accordingly, the plurality of line areas belonging to the dummy correction value calculation range is preferably provided. Thus, when the dummy correction value Hd is calculated, not the correction value Hd obtained according to the characteristic of one nozzle, but the average correction value Hd obtained in consideration of the characteristic of the plurality of nozzles can be calculated. Accordingly, the density irregularity can be averagely corrected on the line areas belonging to the dummy correction value application range.

In this embodiment, the normal correction values Ho of the line areas belonging to the dummy correction value calculation range are simply averaged. However, the invention is not limited thereto, as long as the dummy correction values Hd are calculated based on the normal correction values Ho of the line areas belonging to the dummy correction value calculation range. For example, a weight average may be calculated in such a manner that the weighted values of the line areas closer to the dummy correction value application range may be increased and the weighted values of the line areas more distant from the dummy correction value application range are decreased.

The invention is not limited either to the case where all of the line areas in the dummy correction value calculation range are used. For example, the dummy correction values Hd may be calculated based on the normal correction values Ho of every plurality of line areas among the line areas belonging to the dummy correction value calculation range.

### S06: Storing Dummy Correction Value Hd

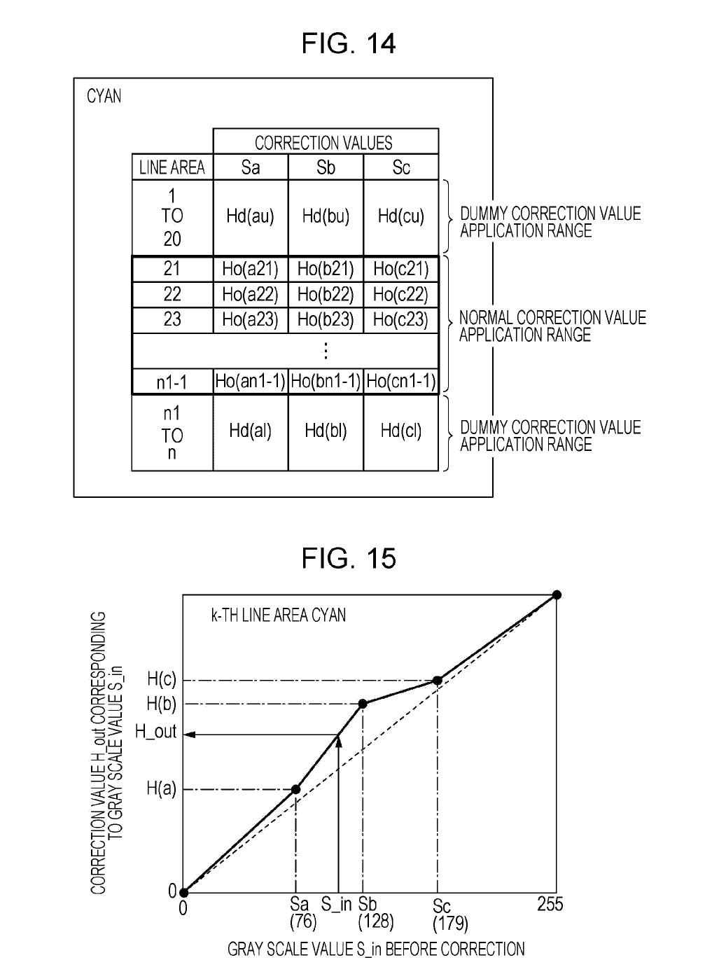

FIG. 14 is a diagram illustrating a completed correction value table. The correction value acquiring program calculates the dummy correction values Hd(u) on the upper end side in the Y direction and the dummy correction values Hd(1) on the lower end side in the Y direction, and then stores the calculated correction values Hd(u) and Hd(1) in the correction value table. The common dummy correction values Hd(u) are applied to the line areas L1 to L20 belonging to the dummy correction value application range on the upper end side. Therefore, the dummy correction values (Hd(au), Hd(bu), and Hd(cu)) on the upper end side are stored for the respective three instruction gray scale values (Sa, Sb, and Sc) in the line areas L1 to L20 of the correction value table. Likewise, the common dummy correction values Hd(1) are applied to the line areas Ln1 to Ln belonging to the dummy correction value application range on the lower end side. Therefore, the dummy correction values (Hd(a1), Hd(b1), and Hd(c1)) on the lower end side are stored for the respective three instruction gray scale values in the line areas Ln1 to Ln of the correction value table. The correction value table for cyan is illustrated, but the correction value acquiring program generates the same correction value table for yellow, magenta, and black.

Finally, the correction value acquiring program stores the generated correction value tables in the memory 13 (corresponding to a storage unit) of the printer 1 for which the correction values are calculated. In this way, the method of manufacturing the printer 1 according to the flowchart of FIG. 7 is completed. Thereafter, the printer 1 is shipped for a user. In the flowchart of FIG. 7, the calculated correction values are stored in the correction value table in the step of calculating the normal correction values Ho and the dummy correction values Hd, but the invention is not limited thereto. In addition, the calculated correction values may be stored in the correction value table in the step of calculating both the correction values Ho and Hd.

### Density Correction Process

The user installs a printer driver in the computer 60 (see FIG. 1) connected to the printer 1 when starting using the printer 1. The printer driver may be recorded in a recording medium such as a CD-ROM or may be downloaded to a computer via the Internet. The printer driver asks the printer 1 connected to the computer 60 to transmit the correction value tables (see FIG. 14) stored in the memory 13 to the computer 60. The printer driver stores the correction value tables transmitted from the printer 1 in an internal memory of the computer 60.

When receiving a print instruction and image data from various application programs, the printer driver generates print data so that the printer 1 performs printing. The printer driver first converts the resolution of the image data from the application program into print resolution by a resolution conversion process. Next, the printer driver converts the image data which is RGB data into YMCK data corresponding to ink colors used in the printing by a color conversion process. Then, referring to the correction value table (see FIG. 14), the printer driver corrects gray scale values (for example, 256 gray scale values) indicated by the pixels with the correction values Ho and Hd for density irregularity for every line area, every color, and every instruction gray scale value.

When a gray scale value S_in before correction indicated by a pixel is the same as one of the instruction gray scale values Sa, Sb, and Sc, the correction value H(a), H(b), or H(c) of the correction value table can be applied without change. For example, when the gray scale value S_in before correction is equal to Sc, a gray scale value S_out after correction is calculated by the following expression.

S_out=Sc×(1+H(c)).

FIG. 15 is a diagram illustrating a method of calculating the correction values H corresponding to the respective gray scale values in a k-th line area of cyan. The horizontal axis represents the gray scale value S_in before correction and the vertical axis represents the correction value H_out corresponding to the gray scale value S_in before correction. The printer driver calculates the correction value H_out corresponding to the gray scale value S_in before correction, when the gray scale value S_in before correction is different from the instruction gray scale value.

For example, when the gray scale value S_in before correction is a value between the instruction gray scale values Sa and Sb, as shown in FIG. 15, the printer driver calculates the correction value H_out by the following expression to perform linear interpolation between the correction value Ha of the instruction gray scale value Sa and the correction value Hb of the instruction gray scale value Sb.

H_out=Ha+{(Hb−Ha)×(S_in−Sa)/(Sb−Sa)}

Next, the printer driver calculates the gray scale value S_out after correction by correcting the gray scale value S_in before correction by the following expression using the calculated correction value H_out.

S_out=S_in×(1+H_out)

When the gray scale value S_in before correction is smaller than the instruction gray scale value Sa, the correction value H_out is calculated by linear interpolation between the smallest gray scale value 0 and the instruction gray scale value Sa. When the gray scale value S_in before correction is greater than the instruction gray scale value Sc, the correction value H_out is calculated by linear interpolation between the largest gray scale value 255 and the instruction gray scale value Sc.

In this way, the printer driver corrects the gray scale values S_in (256-gray-scale data) indicated by the respective pixels of the image data by the correction values H set for every color (YMCK), every line area, and every gray scale value. Thus, the gray scale values S_in of the pixels corresponding to the line area with the density appearing faint are corrected into the gray scale values S_out with the dark density, whereas the gray scale values S_in of the pixels corresponding to the line area with the density appearing dark are corrected into the gray scale values S_out with the faint density.

After the density correction process, the printer driver converts the data with the large number of gray scales (256 gray scales) into data (data indicating ON and OFF of dots) with the small number of gray scales which can be printed by the printer 1 by a halftone process. Finally, the printer driver changes the order in which matrix-shaped image data are transmitted to the printer 1 by rasterization processing. The printer driver transmits both the print data subjected to the above processes and command data (a print instruction, a print mode, or the like) to the printer 1. The printer 1 performs the printing based on the received print data.

### Second Embodiment

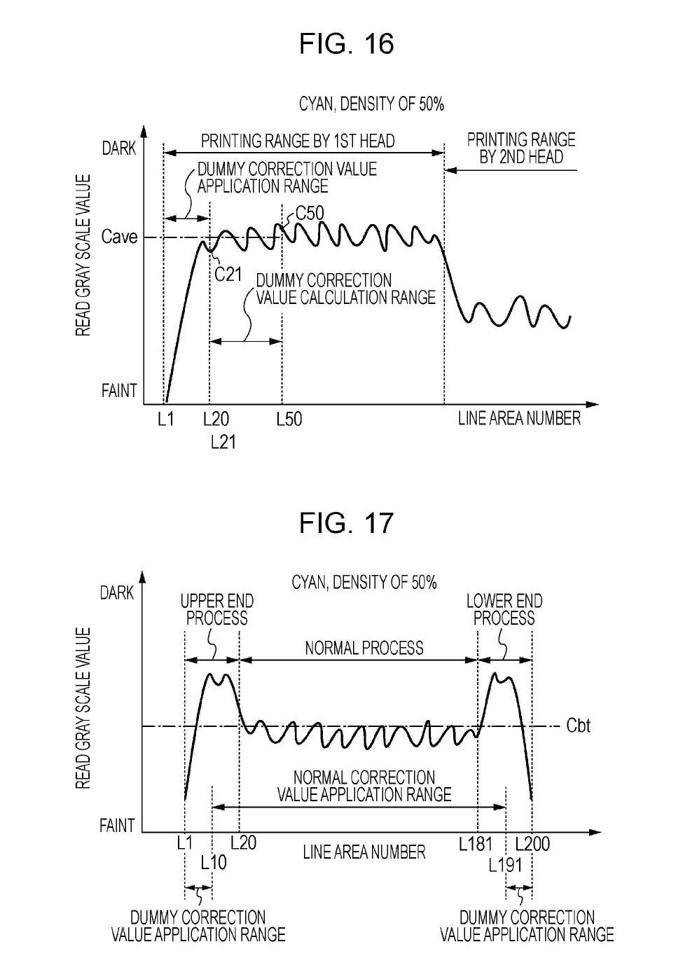

FIG. 16 is a diagram illustrating a method of calculating the dummy correction values Hd according to a second embodiment. In the above-described first embodiment, the average values of the normal correction values Ho of the line areas belonging to the dummy correction value calculation range are calculated as the dummy correction values Hd. In the second embodiment, however, the dummy correction values Hd are calculated based on an average values Cave of the read gray scale values of the line areas belonging to the dummy correction value calculation range. That is, the average values Cave (={C21+C22+ . . . +C50}/30) of the read gray scale values of the line areas (L21 to L50 in FIG. 16) belonging to the dummy correction value calculation range, that is, the dummy correction values Hd may be calculated as the read gray scale values of the line areas (L1 to L20 in FIG. 16) of the dummy correction value application range by the same calculation method as the method (see FIGS. 11A and 11B) of calculating the normal correction values Ho.

In this case, the dummy correction value calculation range also includes the line areas printed by the heads 41 printing the line areas of the dummy correction value application range. Moreover, the dummy correction value calculation range does not include the line areas printed by the heads 41 printing the line area in the dummy correction value application range and the line areas printed by the other heads 41. Thus, the average value Cbt of the read gray scale values of the line areas belonging to the dummy correction value calculation range becomes a value close to the actual density (read gray scale value) of the line areas belonging to the dummy correction value application range, thereby suppressing the density irregularity in the line areas belonging to the dummy correction value application range like the other line areas.

### Third Embodiment

FIG. 17 is a diagram illustrating the read gray scale values of the test patterns printed by the printer 1 including one head 41. The printer 1 including the plurality of heads 41 has hitherto been described as an example, as shown in FIG. 3, but the invention is not limited thereto. In the printer 1 including the plurality of heads 41, variation occurs in the densities of the images printed by the respective heads 41 due to the characteristic difference of the respective heads 41, as show in FIG. 9A. Therefore, for example, when a difference is large between the density of each image printed by the heads 41 printing the line areas (that is, the line areas in the dummy correction value application range) on which the margin have an influence and the density of each image printed by the other heads 41 and the correction amounts of the line areas in the vicinity of the line areas on which the margins have an influence are large, a problem may arise particularly in that the boundary between the line areas on which the margins have an influence and the line areas on which the margins have no influence is visibly noticeable.

For example, however, the characteristics of the end nozzles may sometimes be different from the characteristics of the other nozzles even in not only the plurality of heads 41 but also the nozzle lines of the same head 41. In this case, as in the printing method of FIG. 5, it is assumed that the printing method including the upper end process, the lower end process, and the normal process is performed. The small number line areas (L1 to L20 in FIG. 17) printed by the upper end process are printed by the upper end nozzles of the nozzle line and the large number line areas (L180 to L200) printed by the lower end process are printed by the lower end nozzles of the nozzle line. Here, the end nozzles of the nozzle lines eject more ink than the other nozzles. As shown in FIG. 17, therefore, the read gray scale values of the line areas printed in the upper end process and the lower end process are larger than the read gray scale values of the line areas (L21 to L180) printed by the normal process (becoming values with dark density).

As illustrated, the line areas (L1 to L10) on the upper end side on which the margin has an influence and the line areas (L191 to L200) on the lower end side on which the margin has an influence are set as the dummy correction value application range, and the 11th line area to the 190th line area are set as the normal correction value application range. In addition, the correction value acquiring program calculates the average value Cbt of the read gray scale values of the line areas (L11 to L190) belonging to the normal correction value application range, that is, the normal correction value Ho as a target value. Then, in the normal correction value application range, the number of line areas printed in the upper end process and the lower end process is smaller than the number of line areas printed in the normal process, and the correction amount of the line areas in the upper end process and the lower end process is more than the correction amount of the line areas in the normal process. Therefore, when the correction values of the line areas on which the margins have an influence are 0, as in the above-described comparative example (see FIG. 9C), the boundary between the line area on which the margin has an influence and the line area on which the margin has no influence is visibly noticeable.

Accordingly, even in the printer including only one head 41, the correction values (dummy correction values Hd) of the line areas on which the margins have an influence may be also calculated based on the correction values (or the read gray scale values) of the near other line areas thereof. The line areas in the dummy correction value calculation range are set to the line areas printed by the upper end process (or the lower end process) like the line areas in the dummy correction value application range. Thus, in the line areas in the dummy correction value application range printed by the end nozzles, the density irregularity can be corrected with the correction values according to the characteristics of the end nozzles. As a consequence, the boundary between the line area on which the margin has an influence and the line area on which the margin has no influence is barely visibly noticeable.

### Other Embodiments

In the above-described embodiments, the printing system including the ink jet printer has mainly been described, but the disclosure of the method and the like of calculating the correction values for the density irregularity is included. The above-described embodiments have been described in order to facilitate the easy understanding of the invention, but the invention is not limited thereto. Of course, the invention can be modified and improved without departing from the gist of the invention and the invention includes the equivalents. In particular, the following embodiment is also included in to the invention.

### Printer

In the above-described embodiments, the printer has hitherto been described in which the process of forming an image while moving the head unit 40 relative to a continuous sheet transported to the print area in the medium transport direction and the process of moving the head unit 40 in the sheet width direction are repeated to print an image and then a part of the medium on which an image is not printed is transported to the print area. However, the invention is not limited thereto. For example, a printer may be used which repeats a process of forming an image on a single sheet while moving a head in a movement direction and a process of transporting the single sheet relative to the head in a transport direction intersecting the movement direction. Alternatively, a printer (so-called line printer) may be used which forms an image while a medium is transported below the fixed head unit 40 in which the plurality of heads 41 are lined up in a nozzle line direction.

The entire disclosure of Japanese Patent Application No. 2010-073652, filed Mar. 26, 2010 is expressly incorporated by reference herein.

What is claimed is:

1. A printing apparatus comprising:
a plurality of heads each including a nozzle line in which nozzles ejecting ink toward a medium are lined up in a predetermined direction,
wherein based on a correction value calculated by a correction value calculating method including the following (a) to (d), the printing apparatus performs printing by ejecting the ink from the nozzles and forming dot lines in an intersection direction intersecting the predetermined direction, while moving the nozzle lines and the medium relatively in the intersection direction, and
wherein the correction value calculating method includes
(a) printing a pattern based on an instruction gray scale value indicating a predetermined density by the printing apparatus,
(b) acquiring a read gray scale value, which is a result obtained when a scanner reads the pattern, for each line area which is an area in which the dot line is formed in the intersection direction on the medium,
(c) calculating a first correction value, which is a correction value of each line area corresponding to a middle portion of the pattern in the predetermined direction, based on the read gray scale value of each line area corresponding to the middle portion of the pattern, and
(d) calculating a second correction value, which is a correction value of the line area corresponding to an end portion of the pattern in the predetermined direction, based on the read gray scale value of the line area in the vicinity of the line area corresponding to the end portion of the pattern.

2. The printing apparatus according to claim 1,
wherein in the (a) printing of the pattern, the printing apparatus including the plurality of heads each including the nozzle line prints the pattern, and
wherein in the (d) calculating of the second correction value, the line area used to calculate the second correction value includes the line area to which the same head as the head allocated to the line area corresponding to the end portion of the pattern is allocated.

3. The printing apparatus according to claim 2, wherein in the (d) calculating of the second correction value, the line area used to calculate the second correction value does not include the line area to which the head different from the head allocated to the line area corresponding to the end portion of the pattern is allocated.

4. The printing apparatus according to claim 2, wherein in the (d) calculating of the second correction value, the line area used to calculate the second correction value does not include the line area corresponding to the end portion of the pattern.

5. The printing apparatus according to claim 1, wherein in the (d) calculating of the second correction value, the second correction value is calculated based on the first correction value of the line area used to calculate the second correction value.

6. The printing apparatus according to claim 5, wherein in the (d) calculating of the second correction value, an average value of the first correction values of a plurality of the line areas used to calculate the second correction value is calculated as the second correction value.

7. A correction value calculating method comprising:
(a) printing a pattern based on an instruction gray scale value indicating a predetermined density by a printing apparatus, which performs the printing by ejecting ink from nozzles and forming dot lines in an intersection direction intersecting a predetermined direction, while moving nozzle lines in which the nozzles ejecting the ink on a medium are lined up in the predetermined direction and the medium relatively in the intersection direction;
(b) acquiring a read gray scale value, which is a result obtained when a scanner reads the pattern, for each line area which is an area in which the dot line is formed in the intersection direction on the medium;
(c) calculating a first correction value, which is a correction value of each line area corresponding to a middle portion of the pattern in the predetermined direction, based on the read gray scale value of each line area corresponding to the middle portion of the pattern; and
(d) calculating a second correction value, which is a correction value of the line area corresponding to an end portion of the pattern in the predetermined direction, based on the read gray scale value of the line area in the vicinity of the line area corresponding to the end portion of the pattern.

8. A recording medium recording a program causing a computer to calculate a correction value for correcting density of an image printed by a printing apparatus,
wherein the printing apparatus ejects ink from nozzles and forms dot lines in an intersection direction intersecting a predetermined direction, while moving nozzle lines in which the nozzles ejecting the ink on a medium are lined up in the predetermined direction and the medium relatively in the intersection direction, and
wherein the program causes the computer to execute the functions of:
(a) printing a pattern based on an instruction gray scale value indicating a predetermined density by the printing apparatus;
(b) acquiring a read gray scale value, which is a result obtained when a scanner reads the pattern, for each line area which is an area in which the dot line is formed in the intersection direction on the medium;
(c) calculating a first correction value, which is a correction value of each line area corresponding to a middle portion of the pattern in the predetermined direction, based on the read gray scale value of each line area corresponding to the middle portion of the pattern; and
(d) calculating a second correction value, which is a correction value of the line area corresponding to an end portion of the pattern in the predetermined direction, based on the read gray scale value of the line area in the vicinity of the line area corresponding to the end portion of the pattern.
